(19) United States
(12) Patent Application Publication
(10) Pub. No.: US 2012/0127509 A1
(43) Pub. Date: May 24, 2012

(54) Activation Code Provided with Discrete Increment of Paper Substrate for Activating Remotely Accessible Printer Controller Software

(75) Inventor: RICHARD D. FABER, Memphis, TN (US)

(73) Assignee: INTERNATIONAL PAPER COMPANY, Memphis, TN (US)

(21) Appl. No.: 13/298,877

(22) Filed: Nov. 17, 2011

Related U.S. Application Data
(60) Provisional application No. 61/416,367, filed on Nov. 23, 2010.

(51) Int. Cl. G06K 15/02

(52) U.S. Cl. 358/1.14; 358/1.15

(57) ABSTRACT

A system which has an electronic database for entry of an activation code provided with a discrete increment of a printable paper substrate and printer controller software for use with the printable paper substrate which is remotely accessible and which is activated after entry by a user of the activation code into the electronic database. Also, a method for providing the discrete increment of the printable paper substrate to the user, wherein the discrete increment is provided with the activation code which the user enters into the electronic database to activate code to activate the remotely accessible printer controller software for use with the printable paper substrate, as well as a product including the discrete increment of the printable paper substrate along with the activation code to permit the user to activate the remotely accessible printer controller software.

### FIELD OF THE INVENTION

The present invention broadly relates to a system which comprises an electronic database for entry of an activation code provided with a discrete increment of a printable paper substrate; and printer controller software for use with the printable paper substrate which is remotely accessible by a user and which activated after entry by the user of the activation code into the electronic database. The present invention also broadly relates to a method for providing the discrete increment of the printable paper substrate to the user, wherein the discrete increment is provided with the activation code which the user enters into the electronic database to activate the remotely accessible printer controller software for use with the printable paper substrate. The present invention further broadly relates to a product comprising the discrete increment of the printable paper substrate which is provided with the activation code which the user enters into the electronic database to activate the remotely accessible printer controller software to permit the user to use the printer controller software with the printable paper substrate.

### BACKGROUND

Products may be offered by manufacturers with other accessories to enhance the desirability and salability of the product. In some instances, these accessories may be associated with the product (or a promotional sample of the product) as a marketing tool to create enhanced interest by users in purchasing further quantities of the product from the manufacturer. One such accessory which may be associated with such products for promotional and marketing purposes is computer software. For example, such associated software may provide instructions on how to best use the product being promoted or sold by the manufacturer, or may provide enhancements in the ability to use the promoted or sold product.

This software may be provided by the manufacturer as a physical copy associated with the product, the packaging for product, etc. But providing physical copies of the software with the product being distributed or sold by the manufacturer may have certain disadvantages. For example, associating the software physically (e.g., as a CD or DVD) with the product may make the product more difficult to package for distribution or sale, unduly bulky or awkward to distribute or sell, etc. Providing physical copies of the software may also lead to instances where the physical copy provided is damaged or corrupted so that it is not longer useable. In addition, providing an associated physical copy of the software with the product may create additional cost, especially if the software may be changed or upgraded over time, thus making prior physical copies of the software outdated or obsolete.

But what may be of particular concern to the manufacturer of the product is controlling who has the ability to use the software associated with that product, and to what degree. For example, the manufacturer may have tailored the characteristics of the product being sold to operate advantageously with the associated software and vice versa. The manufacturer may also want to encourage future purchases of the product by providing use of the associated software for a limited period time, for example, limited to the quantity of product provided with each sale, etc. Even if the software operates more advantageously with the associated product, the software may still provide significant benefits or advantages with different but similar products. This may cause others users who have not bought the manufacturer's product to be tempted to copy and use the software with these other products such that the promotional or marketing value of the software for selling the manufacturer's product is minimized or even eliminated. In fact, if the software physically associated with the product being distributed or sold does not require a security (e.g., activation) code for use, the manufacturer of the product may have minimal or no ability to control what products the software is used with, and for how long.

### SUMMARY

According to a first broad aspect of the present invention, there is provided in a system comprising:
an electronic database for entry of an activation code provided with a discrete increment of a printable paper substrate; and
printer controller software for use with the printable paper substrate which is remotely accessible by a user and which is activated after entry by the user of the activation code into the electronic database.

According to a second broad aspect of the present invention, there is provided a method comprising the following steps:
a. providing a discrete increment of a printable paper substrate to a user, wherein the discrete increment is provided with an activation code; and
b. entering the activation code into an electronic database to permit the user to activate remotely accessible printer controller software for use with the printable paper substrate.

According to a third broad aspect of the present invention, there is provided a product comprising:
a discrete increment of a printable paper substrate; and
an activation code provided with the discrete increment and which may be entered by a user into an electronic database to activate remotely accessible printer controller software to permit the user to use the printer controller software with the printable paper substrate.

### BRIEF DESCRIPTION OF THE DRAWINGS

The invention will be described in conjunction with the accompanying drawings, in which:

FIG. 1 is a schematic diagram which shows an illustrative system according to an embodiment of the present invention; and

FIG. 2 is a flowchart which shows an illustrative method according to an embodiment of the present invention.

### DETAILED DESCRIPTION

It is advantageous to define several terms before describing the invention. It should be appreciated that the following definitions are used throughout this application.

### DEFINITIONS

Where the definition of terms departs from the commonly used meaning of the term, applicant intends to utilize the definitions provided below, unless specifically indicated.

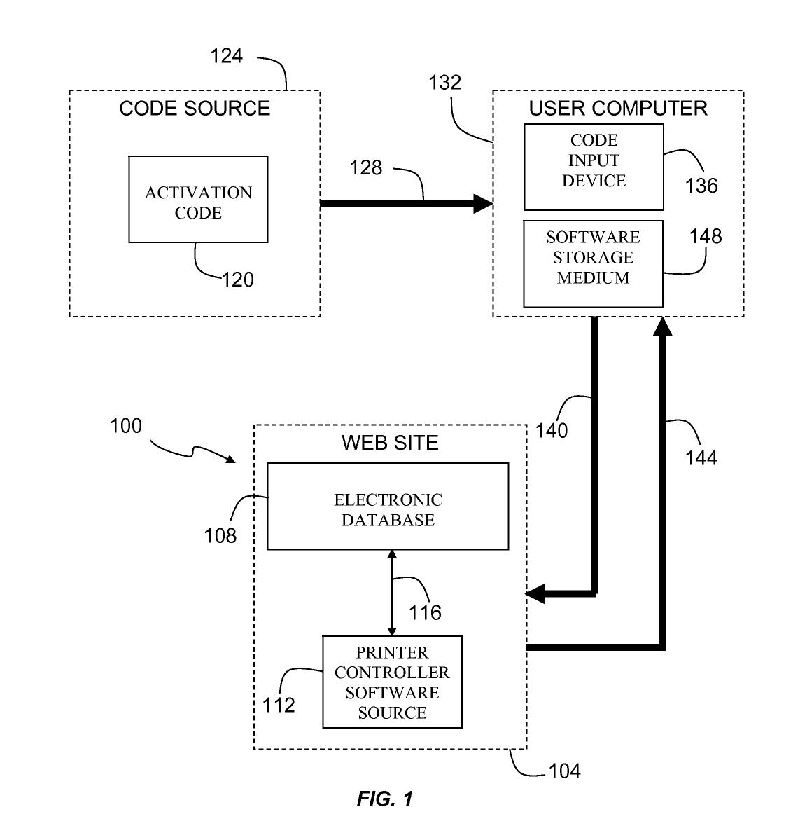

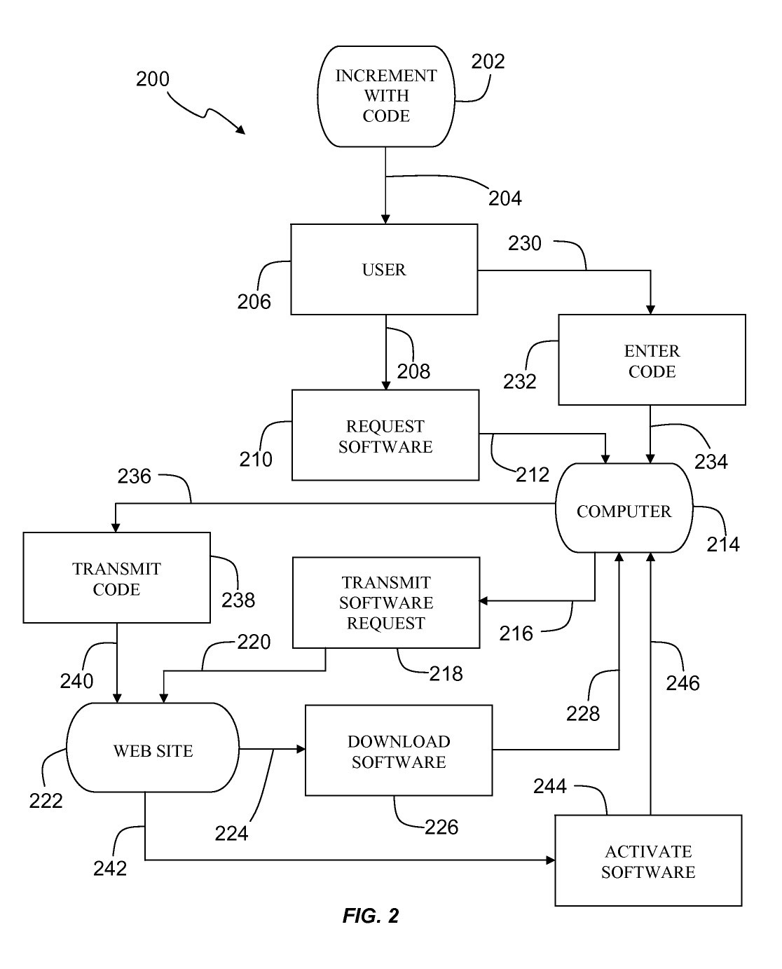

For the purposes of the present invention, directional terms such as “top”, “bottom”, “upper,” “lower,” “side,” “front,” “frontal,” “forward,” “rear,” “rearward,” “back,” “trailing,” “above”, “below”, “left”, “right”, “horizontal”, “vertical”, “upward”, “downward”, etc. are merely used for convenience in describing the various embodiments of the present invention. The embodiments shown in FIGS. 1 and 2 may be flipped over, rotated by 90° in any direction, etc.

For the purposes of the present invention, the term “paper substrate” refers to a fibrous web that may be formed, created, produced, etc., from a mixture, furnish, etc., from paper fibers, plus any other optional papermaking additives such as, for example, fillers, wet-strength agents, optical brightening agents (or fluorescent whitening agent), etc. Paper substrates may include an uncoated paper substrate, coated paper substrate, etc.

For the purposes of the present invention, the term “printable paper substrate” refers to any paper substrate which may be printed on with a printer colorant.

For the purposes of the present invention, the term “discrete increment” refers to a distinct quantity of printable paper substrate provided (e.g., distributed, sold, offered for sale, etc.) to a user thereof. A discrete increment may include a single sheet, a plurality of sheets, a ream, etc.

For the purposes of the present invention, the term “ream” refers to the conventional sense of the term as providing a quantity of printable paper substrate (e.g., packaged quantity of printable paper substrate) in the range of, for example, from about 480 to about 516 sheets (e.g., 480, 500 or 516 sheets).

For the purposes of the present invention, the term “uncoated paper substrate” refers to a paper substrate which has 0 or substantially 0 paper surface loading of a coating composition present on both sides or surfaces of the paper substrate.

For the purposes of the present invention, the term “coated paper substrate” refers to a paper substrate which has a surface loading of a coating composition present on one or both, sides or surfaces of the paper substrate.

For the purposes of the present invention, the term “calendered paper” refers to a paper substrate which has been subjected to calendering to, for example, smooth out the paper for enabling printing and writing on the paper substrate, to increase the gloss on the paper surface, etc. For example, calendering may involve a process of using pressure (and optionally temperature and moisture) for embossing a smooth surface on the still rough paper surface. Calendering of a paper substrate may be carried out on a calendar which may comprise a series of rolls at the end of a papermaking machine (on-line), or separate from the papermaking machine (off-line). Calendering may include supercalendering, hot-soft calendering, moisture-gradient calendering, extended nit calendering, belt calendering, etc. See G. A. Smook, Handbook for Pulp and Paper Technologists (2^{nd} Edition, 1992), pages 273-78, the entire contents and disclosure of which is herein incorporated by reference, for a general description of calendering, as well as devices for carrying out calendering.

For the purposes of the present invention, the term “paper filler” refers commonly to mineral products (e.g., calcium carbonate, kaolin clay, etc.) which may be used in paper making to reduce materials cost per unit mass of the paper substrate, increase opacity, increase smoothness, etc. These mineral products may be finely divided, for example, the size range of from about 0.5 to about 5 microns.

For the purposes of the present invention, the term “substrate coating composition” refers to those compositions for coating paper substrates which may comprise, for example: a substrate pigment component; a metal salt drying agent; a cationic dye fixing agent; and a substrate pigment binder. These substrate coating compositions may also include other optional additives, such as, for example, plastic pigments, optical brightening agents, fluorescent whitening agents, solvents, diluents, anti-scratch and mar resistance agents, etc. These substrate coating compositions may be formulated as an aqueous slurry, a colloidal suspension, a liquid mixture, a thixotropic mixture, etc.

For the purposes of the present invention, the term “solids basis” refers to the weight percentage of each of the respective solid materials (e.g., pigment component; a metal salt drying agent; a cationic dye fixing agent; a pigment binder; plastic pigment, optical brightening agent, etc.) present in the coating composition, coating, etc., in the absence of any liquids (e.g., water). Unless otherwise specified, all percentages given herein for the solid materials are on a solids basis.

For the purposes of the present invention, the term “solids content” refers to the percentage of non-volatile, non-liquid components (by weight) that are present in the composition, etc.

For the purposes of the present invention, the term “substrate pigment” refers to a material (e.g., a finely divided particulate matter) which may be used or may be intended to be used to affect optical properties of the paper substrate and which becomes part of the printable paper substrate prior to use (e.g., printing).

For the purposes of the present invention, the term “calcium carbonate” refers to various calcium carbonates which may be used as substrate pigments, such as precipitated calcium carbonate (PCC), ground calcium carbonate (GCC), modified PCC and/or GCC, etc.

For the purposes of the present invention, the term “precipitated calcium carbonate (PCC)” refers to a calcium carbonate which may be manufactured by a precipitation reaction and which may used as a substrate pigment. PCC may comprise almost entirely of the calcite crystal form of CaCO₃. The calcite crystal may have several different macroscopic shapes depending on the conditions of production. Precipitated calcium carbonates may be prepared by the carbonation, with carbon dioxide (CO₂) gas, of an aqueous slurry of calcium hydroxide (“milk of lime”). The starting material for obtaining PCC may comprise limestone, but may also be calcined (i.e., heated to drive off CO₂), thus producing burnt lime, CaO. Water may added to “slake” the lime, with the resulting “milk of lime,” a suspension of Ca(OH)₂, being then exposed to bubbles of CO₂ gas. Cool temperatures during addition of the CO₂ tend to produce rhombohedral (blocky) PCC particles. Warmer temperatures during addition of the CO₂ tend to produce scalenohedral (rosette-shaped) PCC particles. In either case, the end the reaction occurs at an optimum pH where the milk of lime has been effectively converted to CaCO₃, and before the concentration of CO₂ becomes high enough to acidify the suspension and cause some of it to redissolve. In cases where the PCC is not continuously agitated or stored for many days, it may be necessary to add more than a trace of such anionic dispersants as polyphosphates. Wet PCC may have a weak cationic colloidal charge. By contrast, dried PCC may be similar to most ground CaCO₃ products in having a negative charge, depending on whether dispersants have been used. The calcium carbonate may be precipitated from an aqueous solution in three different crystal forms: the vaterite form which is thermodynamically unstable, the calcite form which is the most stable and the most abundant in nature, and the aragonite form which is metastable under normal ambient conditions of temperature and pressure, but which may convert to calcite at elevated temperatures. The aragonite form has an orthorhombic shape that crystallizes as long, thin needles that may be either aggregated or unaggregated. The calcite form may exist in several different shapes of which the most commonly found are the rhombohedral shape having crystals that may be either aggregated or unaggregated and the scalenohedral shape having crystals that are generally unaggregated.

For the purposes of the present invention, the term “substrate pigment binder” refers to a binder agent for paper substrates which may be used to improve the substrate pigment binding strength of substrate coating composition, coating, etc. Substrate pigment binders may be hydrophilic. Suitable substrate pigment binders may include synthetic or naturally occurring polymers (or a combination of different polymers), for example, a polyvinyl alcohol (PVOH), starch binders, proteinaceous adhesives such as, for example, casein or soy proteins, etc.; polymer latexes such as styrene butadiene rubber latexes, acrylic polymer latexes, polyvinyl acetate latexes, styrene acrylic copolymer latexes, etc., or a combination thereof. The substrate pigment binder may also be substantially free of starch binders and/or latexes as binders to improve the dry time of the coated substrate of the printable paper substrate and to improve the processability of the substrate of the printable paper substrate during the coating process.

For the purposes of the present invention, the term “substantially free” refers to a composition, coating, etc., having less than about 0.1% of a particular component by weight of the composition, coating, etc.

For the purposes of the present invention, the term “starch binder” refers to a binder agent for substrate pigments and/or paper substrates which comprises starch, a starch derivative, etc., or a combination thereof. Suitable starch binders may be derived from a natural starch, e.g., natural starch obtained from a known plant source, for example, wheat, maize, potato, tapioca, etc. The starch binder may be modified (i.e., a modified starch) by one or more chemical treatments known in the paper starch binder art, for example, by oxidation to convert some of —CH.₂OH groups to —COOH groups, etc. In some cases the starch binder may have a small proportion of acetyl groups. Alternatively, the starch binder may be chemically treated to render it cationic (i.e., a cationic starch) or amphoteric (i.e., an amphoteric starch), i.e., with both cationic and anionic charges. The starch binder may also be a starch converted to a starch ether, or a hydroxyalkylated starch by replacing some —OH groups with, for example, —OCH₂CH₂OH groups, —OCH2CH₃ groups, —OCH₂CH₂CH₂OH groups, etc. A further class of chemically treated starch binders which may be used are known as the starch phosphates. Alternatively, raw starch may be hydrolyzed by means of a dilute acid, an enzyme, etc., to produce a starch binder in the form of a gum of the dextrin type.

For the purposes of the present invention, the term “metal salt drying agent” refers to those metal salts which may improve the dry time of inks printed on printable paper substrates by, for example, ink jet printing processes. These metal salt drying agents may include but are not limited to salts containing calcium or magnesium (e.g., divalent water-soluble metals salts). The counter ions may include chloride, sulfate, nitrate, hydroxide, silicate, etc. Illustrative metal salt drying agents may include metal salts such as sodium chloride, calcium chloride, calcium nitrate, magnesium chloride, magnesium nitrate, aluminum chloride, sodium sulfate, aluminum chloride, aluminum nitrate, aluminum sulfate, potassium chloride, sodium aluminum sulfate, vanadium chloride, magnesium sulfate, sodium silicates, etc., or combinations thereof.

For the purposes of the present invention, the term “cationic dye fixing agent” refers to those cationic compounds (e.g., nitrogen-containing compounds) or mixtures of such compounds which may aid in fixing, trapping, etc., inks printed by ink jet printing processes, and which may provide other properties, including water fastness. These cationic dye fixing agents may include compounds, oligomers and polymers which contain one or more quaternary ammonium functional groups, and may include cationic water-soluble polymers that are capable of forming a complex with anionic dyes. Such functional groups may vary widely and may include substituted and unsubstituted amines, imines, amides, urethanes, quaternary ammonium groups, dicyandiamides and the like. Illustrative of such compounds are polyamines, polyethyleneimines, polymers or copolymers of diallyldimethyl ammonium chloride (DADMAC), copolymers of vinyl pyrrolidone (VP) with quaternized diethylaminoethylmethacrylate (DEAMEMA), polyamides, cationic polyurethane latexes, cationic polyvinyl alcohols, polyalkylamines dicyandiamid copolymers, amine glycidyl addition polymers, poly[oxyethylene (dimethyliminio) ethylene (dimethyliminio) ethylene] dichlorides, etc., or combinations thereof. These cationic dye fixing agents may include low to medium molecular weight cationic polymers and oligomers having a molecular equal to or less than 100,000, for example, equal to or less than about 50,000, e.g., from about 10,000 to about 50,000. Illustrative of such materials are polyalkylamine dicyandiamide copolymers, poly[oxyethylene(dimethyliminio ethylene(dimethyliminioethylene] dichlorides and polyamines having molecular weights within the desired range. Cationic dye fixing agents suitable herein may include low molecular weight cationic polymers such as polyalkylamine dicyandiamid copolymer, poly[oxyethylene (dimethyliminio)ethylene(dimethyliminio)ethylene] dichloride, for example, low molecular weight polyalkylamine dicyandiamid copolymers. See U.S. Pat. No. 6,764,726 (Yang et al.), issued Jul. 20, 2004, the entire disclosure and contents of which is hereby incorporated by reference.

For the purposes of the present invention, the term “brightness” refers to the diffuse reflectivity of paper, for example, at a mean wavelength of light of 457 nm. As used herein, brightness of the paper substrate may be measured by, for example, in terms of GE Brightness or ISO Brightness.

For the purposes of the present invention, the term “opacity” refers to the ability of a paper to hide things such as print images on subsequent sheets or printed on the back, e.g., to minimize, prevent, etc., show-through, etc. As used herein, opacity of the paper substrate may be measured by, for example, in terms of TAPPI opacity and show-through. TAPPI opacity may be measured by T425 om-91.

For the purposes of the present invention, the term “show-through” refers to the degree to which printing on one side of a paper sheet may be seen through the other side of the same sheet. Show-through may correlate to opacity of the paper, the degree of ink penetration into the paper, etc. Values for show-through may be determined by the Show-Through Test Methodology, which is attached hereto as an appendix and which is hereby incorporated by reference herein in its entirety.

For the purposes of the present invention, the term “paper smoothness” refers to the extent to which the paper surface deviates from a planar or substantially planar surface, as affected by the depth of the paper substrate, the paper substrate width, numbers of departure from that planar surface, etc. As used herein, the paper smoothness of a paper substrate may be measured by, for example, in terms of Parker Print Smoothness. Parker Print Smoothness may be measured by TAPPI test method T 555 om-99.

For the purposes of the present invention, the term “print quality” refers to those factors, features, characteristics, etc., that may influence, affect, control, etc., the appearance, look, form, etc., of a printed image on the printable paper substrate. As used herein, print quality of, for example, a paper substrate may be measured by, for example, in terms of one or more of: (1) print density/contrast (e.g., for BW/color/monochrome); (2) color gamut or color richness (e.g., for digital printing such as ink jet printing, laser printing, etc.); (3) dry times); (4) print gloss or print mottle; (5) etc. For example, black optical print density may be measured by TAPPI method 1213 sp-03. Print mottle may be measured based on 2nd cyan values according to the method disclosed in U.S. Published Application No. 20060060317 (Roding, et al.), published Mar. 23, 2006, which is herein incorporated by reference in its entirety.

For the purposes of the present invention, the term “gloss” refers to the ability of a printable paper substrate, such as paper, to reflect some portion of the incident light at the mirror angle. Gloss may be based on a measurement of the quantity of light specularly reflected from the surface of a paper specimen at a set angle, for example, at 75 degrees, such as in the case of 75 degree gloss (and as measured by TAPPI test method T 480 om-92).

For the purposes of the present invention, the term “print gloss” refers to a gloss measurement made on a printed substrate such as paper.

For the purposes of the present invention, the term “digital printing” refers to reproducing, forming, creating, providing, etc., digital images on a printable paper substrate. Digital printing may include laser printing, ink jet printing, etc.

For the purposes of the present invention, the term “laser printing” refers to a digital printing technology, method, device, etc., that may use a laser beam to create, form produce, etc., a latent image on, for example, a photoconductor drum. The light of laser beam may later create charge on the drum which may then pick up toner which carries an opposite charge. This toner may then be transferred to the paper and the resulting print image created, formed, produced, etc., fused to the printable paper substrate through, for example, a fuser.

For the purposes of the present invention, the term “electrophotographic recording process” refers to a process which records images on a printable paper substrate by xerography or electrophotography. In an electrophotographic process, the image is often formed by toner particles which are deposited one surface or side of the printable paper substrate, and are then thermally fixed and/or fused to that one surface or side of the printable paper substrate, for example, by heating. In electrophotographic recording, the printable paper substrate may have two relatively smooth or flat sides or surfaces, or may have one side or surface which is textured, uneven or nonsmooth/nonflat, while the other side or surface is relatively smooth or flat.

For the purposes of the present invention, the term “ink jet printing” refers to a digital printing technology, method, device, etc., that may form images on a printable paper substrate by spraying, jetting, etc., tiny droplets of liquid inks onto the printable paper substrate through the printer nozzles. The size (e.g., smaller size), precise placement, etc., of the ink droplets may be provide higher quality ink jet prints. Ink jet printing may include continuous ink jet printing, drop-on-demand ink jet printing, etc.

For the purposes of the present invention, the term “print density” refers to the optical density which is a measure of the light absorbing property of a print image. It may be expressed as the logarithm of the reciprocal to the base 10 of the reflectance from the print image being measured. For example, the higher the print density, the darker the print image may appear. Higher print densities provide a higher contrast, a sharper image for viewing, etc. An X-Rite 418 reflection Densitometer may be used to measure black optical density.

For the purposes of the present invention, the term “print contrast” refers to the difference in print density between printed and unprinted areas.

For the purposes of the present invention, the term “color gamut” refers to the total collection of possible colors in any color reproduction system and may be defined by a complete subset colors. A higher color gamut value indicates a more vivid color print quality. Color gamut may be obtained by measuring the CIE L*, a*, b* of a series of color blocks, including white (unprinted area), cyan, magenta, yellow, red, green, blue and black. The CIE L* represents the whiteness. The value of L* may range from zero (representing black) to 100 (representing white or a perfectly reflecting diffuser). The value of a* represents the degree of green/red. A positive a* is red, while a negative a* is green. A positive b* is yellow, while a negative b* is blue. The CIE L*, a* and b* values may be measured by X-Rite 528 using a D65 light source and a 10-degree viewing angle.

For the purposes of the present invention, the term “color richness” refers to a more vivid or vibrant color print with high print density and high color gamut values.

For the purposes of the present invention, the term “print mottle” refers to non-uniformity in the print image which may be due to unevenness in ink lay, non-uniform ink absorption, etc., across the printable paper substrate surface. Print mottle may be measured using a scanner based mottle tester such as the C3PATX03 Formation and Mottle Test with an Agfa Model DUOSCAN scanner. The printable paper substrate sample to be tested is first printed on a test ink jet printer. The test pattern must include a block of solid black (100%) image. The color block is a square of about 20-50 mm by 20-50 mm. After 20 minutes of waiting time, or when the printed image is fully dried, the printed sample is positioned on the scanner with printed face down. The scanner is set at a resolution of 500 ppi (pixel per inch). A Verity software (Verity IA LLC, 2114 Sunrise Drive, Appleton, Wis. 54914) may be used to analyze the test data from the scanner. An appropriate dimension for testing based on the color block dimension is set. Two mottle indices may be measured: Micro Mottle Index and Macro Mottle Index. The Micro Mottle Index measures density variations within an area of 0.1 in²; while the macro mottle index measures the density variations of the averaged density values of each square of 0.1 in². The lower the mottle index value, the better the print quality.

For the purposes of the present invention, the term “color-to-color bleed” refers to the spreading of one color ink into another color ink on paper which may reduce the resolution of the colored text and lines on a colored background. For example blue and black bars may be printed over a yellow color background. Green and black bars may be printed over magenta color background, and red and black bars may be printed over cyan color background. The smallest distance in microns between two color bars without bridging (or color intruding more than half way to the neighboring color bar) is recorded as the color-to-color bleed index. In other words, the smaller the value of color-to-color bleed, the better the print quality. Distances which may be tested include 50 microns, 100 microns, 150 microns, 300 microns, etc. In some embodiments of the present invention, the tested distance may reach 150 microns or less before bridging (bleed) occurs, which may be considered a “good” color-to-color bleed property.

For the purposes of the present invention, the term “liquid” refers to a non-gaseous fluid composition, compound, material, etc., which may be readily flowable at the temperature of use (e.g., room temperature) with little or no tendency to disperse and with a relatively high compressibility.

For the purposes of the present invention, the term “viscosity,” with reference to coating compositions, refers to Brookfield viscosity. The Brookfield viscosity may be measured by a Brookfield viscometer at 150° F., using a #5 spindle at 100 rpm.

For the purposes of the present invention, the term “substrate surface loading” refers to amount of coating present on a given side or surface of the substrate being treated. Substrate surface loading may be defined in terms of grams of substrate coating composition per square meter of paper substrate (hereinafter referred to as “gsm”).

For the purposes of the present invention, the term “room temperature” refers to the commonly accepted meaning of room temperature, i.e., an ambient temperature of 20° to 25° C.

For the purposes of the present invention, the term “coating” refers to one or more layers, coverings, films, skins, etc., formed, created, prepared, etc., from a substrate coating composition which remains predominantly on the surface(s) of the substrate of a printable paper substrate.

For the purposes of the present invention, the term “remains predominantly on the surface(s) of the printable paper substrate” refers to the substrate coating composition or coating remaining primarily on the surface of the printable paper substrate, and not being absorbed by or into the interior of the paper substrate.

For the purpose of the present invention, the term “treating” with reference to the substrate coating composition may include depositing, applying, spraying, coating, daubing, spreading, wiping, dabbing, dipping, etc.

For the purpose of the present invention, the term “printer” refers to any device which prints an image on a printable paper substrate, including laser printers, ink jet printers, electrophotographic recording devices (e.g., copiers), thermal printers, impact printers (e.g., dot-matrix printers), wide format printers, commercial web printers (e.g., web-pressed printers), scanners, fax machines, etc.

For the purpose of the present invention, the term “identifying printer characteristics” refers to those characteristics of the printer which identify, for example, one or more of its type, model, make, printing characteristics, etc.

For the purpose of the present invention, the term “source of printer colorant” may refers to reservoir, container, bottle, cartridge, etc., holding the printer colorant and from which the printer colorant may be dispensed, dispersed, sprayed, printed, etc.

For the purpose of the present invention, the term “printer cartridge” refers to a replaceable component of a printer which contains printer colorant. Printer cartridges may contain one or more printer colorant reservoirs, electronic contacts and electronic chips for communicating with the printer, etc.

For the purpose of the present invention, the term “printer colorant” may refer to either ink (as used by, for example, an ink jet printer, etc.) and toner (as used by, for example, a laser printer, electrographic recording device, etc.). Printer colorants may be black, white, magenta, cyan, yellow, green, red, brown, blue, orange, purple/lavender/violet, gray, etc., or any combination thereof. A printer which uses, dispenses, deposits, prints, etc., only a black colorant is often referred to as being a “black” or “black and white” printer, while a printer which uses, dispenses, deposits, prints, etc., more than one color (e.g., black, magenta, cyan, yellow, etc.) is often referred to as a “color printer.”

For the purpose of the present invention, the term “ink” refers to printer colorant as used by ink jet printers. Thus the term “ink cartridge” as used herein refers to a replacement ink cartridge for an ink jet printer. The term ink may include dye-based inks and/or pigment-based inks. Dye-based inks comprise a dye which may be an organic molecule which is soluble in the ink medium. Dye-based inks may be classified by their usage, such as acid dyes, basic dyes, or direct dyes, or by their chemical structure, such as azo dyes, which are based on the based on an —N═N— azo structure; diazonium dyes, based on diazonium salts; quinone-imine dyes, which are derivates of quinine, etc. Pigment-based dyes comprise a pigment, which is a solid colored particle suspended in the ink medium. The particle may comprise a colored mineral, a precipitated dye, a precipitated dye which is attached to a carrier particle, etc. Inks are often dispensed, deposited, sprayed, etc., on a printable paper substrate in the form of droplets which then dry on the printable paper substrate to form the print image(s).

For the purposes of the present invention, the term “printed dot” refers to an ink droplet which is printed onto a printable substrate by, for example, an ink jet printer, dot-matrix (impact) printer, etc.

For the purpose of the present invention, the term “toner” refers to printer colorant as used by laser printers. Thus the term “toner cartridge” as used herein refers a replacement toner cartridge for a laser printer. Toner is often dispensed, deposited, etc., on the printable paper substrate in the form of particles, with the particles then being fused on the printable paper substrate to form the image.

For the purpose of the present invention, the term “identifying printer colorant characteristics” refers to those characteristics of a printer colorant which identify, for example, one or more of: its color, type (e.g., ink or toner), type of ink (e.g., dye-based or pigment-based), consistency (e.g., viscosity, fluidity, etc.), how it is deposited (e.g., type of printer), etc.

For the purpose of the present invention, the term “computer” refers to any type of computer system that implements software including an individual computer such as a personal computer, mainframe computer, mini-computer, etc. In addition, computer system refers to any type of network of computers, such as a network of computers in a business, the Internet, personal data assistant (PDA), devices such as a cell phone, a television, a videogame console, a compressed audio or video player such as an MP3 player, a DVD player, a microwave oven, etc. A personal computer is one type of computer system that may include the following components: a case or chassis in a tower shape (desktop) and the following parts: motherboard, CPU, RAM, firmware, internal buses (PIC, PCI-E, USB, HyperTransport, CSI, AGP, VLB), external bus controllers (parallel port, serial port, USB, Firewire, SCSI. PS/2, ISA, EISA, MCA), power supply, case control with cooling fan, storage controllers (CD-ROM, DVD, DVD-ROM, DVD Writer, DVD RAM Drive, Blu-ray, BD-ROM, BD Writer, floppy disk, USB Flash, tape drives, SATA, SAS), video controller, sound card, network controllers (modem, NIC), and peripherals, including mice, keyboards, pointing devices, gaming devices, scanner, webcam, audio devices, printers, monitors, etc.

For the purpose of the present invention, the term “in electronic communication” refers to two or more devices which are able to transmit electronic signals, data, etc., by a wired connection, wireless connection, or a combination of wired and wireless connections.

For the purpose of the present invention, the term “display device” refers to a device (e.g., a monitor) which presents visual images from a computer for viewing. The display device may be incorporated as a component of the computer, or may be a separate device which is in electronic communication with the computer.

For the purpose of the present invention, the term “printer menu” refers to a menu displayed by the display device (e.g., a dialog box, drop down menu, etc.) which provides the user with the ability to make selections, choices, etc., as to the criteria for operating a printer, including print image quality criteria, printer colorant reduction criteria, number of copies, collation, etc.

For the purpose of the present invention, the term “print image quality criteria” refers to any criteria which may be used to determine the quality of the print image.

For the purpose of the present invention, the term “acceptable print image quality” refers to a level of print image quality of the printed image which is considered acceptable by the user visually and/or by an objective test of print quality.

For the purpose of the present invention, the term “printer colorant reduction criteria” refers to any criteria which may be used to determine the degree to which the deposition of printer colorant is reduced to control usage thereof.

For the purpose of the present invention, the term “reduction in total usage” refers to a reduction in usage of the printer colorant relative to the amount of printer colorant normally used to provide an acceptable print image quality.

For the purpose of the present invention, the term “device controller” refers to any combination of hardware and/or software which interacts with and controls the operation of a device such as, for example, a printer, video adapter, network card, sound card, etc. Device controllers which comprise software may also function as “device drivers” (often referred to simply as “drivers”). Drivers simplify programming by acting as an interface between the hardware device and the applications or operating system using the device. Drivers often communicate with the device through, for example, the computer bus or communications subsystem to which the device hardware is connected.

For the purpose of the present invention, the term “printer controller” refers to any combination of hardware and/or software which interacts with and controls the operation of a printer. Printer controllers which comprise software may also function as “print drivers,” i.e., by converting image data to be printed to a form which may be used by the printer to print the image.

For the purpose of the present invention, the term “controls deposition” refers to altering, modifying, maintaining, correcting, regulating, managing, varying, etc., the manner in which the printer colorant is deposited on the printable paper substrate.

For the purpose of the present invention, the term “identifying printer colorant deposition characteristics” refers to those characteristics which identify how the printer colorant is deposited on the printable paper substrate, including one or more of dry time, print density, etc.

For the purpose of the present invention, the term “data” refers to any information, signal, etc., which quantifies, describes, identifies, etc., an attribute, characteristic, property, etc., of a device, machine, equipment, component, parameter, variable, set of variables, etc.

For the purpose of the present invention, the terms “select,” “selecting,” and “selected” refer to picking, choosing, deciding, etc., a criteria presented by, for example, a printer menu.

For the purpose of the present invention, the terms “determine,” “determining,” and “determined” refer to deciding, verifying, ascertaining, establishing, concluding, resolving, etc., a characteristic of, for example, a printer, printer colorant, the source (e.g., printer cartridge) containing the printer colorant, printable paper substrate, etc.

For the purpose of the present invention, the term “software” refers to a general term used to describe any form of programmed machine-readable language or instructions (e.g., object code) that, when loaded or otherwise installed, provides operating instructions to a machine capable of reading those instructions, such as a computer or other type of computer program reader. The term software may include applications such as word processors which perform productive tasks for users, system software such as operating systems which interface with hardware to provide the necessary services for application software, device controllers (e.g., printer controllers such as printer drivers) which control the operation of devices such as display devices (e.g., monitors), printers, etc., and middleware which controls and co-ordinates distributed systems. Software may include programs, etc., that are coded by programming languages like C, C++, Java, etc. Software is usually regarded as anything but hardware, meaning the “hard” are the parts that are tangible (able to hold) while the “soft” part is the intangible objects inside the computer. Software is so called to distinguish it from computer hardware, which encompasses the physical interconnections and devices required to store and execute (or run) the software. At the lowest level, software may comprise a machine language specific to an individual processor. A machine language comprises groups of binary values signifying processor instructions which change the state of the computer from its preceding state. Software may be stored or reside on, as well as be loaded or installed from, one or more floppy disks, CD ROM disks, hard disks (internal or external), or any other form of suitable non-volatile electronic storage medium. Software may also be installed by downloading or by any other form of remote transmission.

For the purpose of the present invention, the term “transmission” refers to any type of transmission that may be carried out electronically by wired methods, wireless methods or combinations thereof. Illustrative electronic transmissions may be carried out by a variety of remote electronic transmission methods, such as by using Local or Wide Area Network (LAN or WAN)-based, Internet-based, or web-based transmission methods, cable television or wireless telecommunications networks, other suitable remote transmission method, etc.

For the purpose of the present invention, the term “printer controller software” refers to software which controls the operation of a printer by controlling the deposition of printer colorant on a printable paper substrate, including the quantity of, pattern of, manner in which, etc., printer colorant is deposited. The printer controller software may operate in response to various types of characteristics, data, criteria, etc., which are inputted, identified, determined, received, selected, etc., including one or more of: (1) the identifying printer characteristics/data determined/received; (2) the identifying printer colorant characteristics/data determined/received; (3) the identifying printer colorant deposition characteristics/data determined/received; (4) the print image quality criteria selected; or (5) the printer colorant reduction criteria selected. The printer controller software may also function as the print driver for the printer.

For the purpose of the present invention, the term “computer hardware” (hereafter referred to as “hardware”) refers to digital circuitry and physical devices of a computer system, as opposed to software, which may be stored on a hardware device such as a hard disk. Illustrative examples of hardware may include the motherboard, CPU, RAM, firmware, internal buses (PIC, PCI-E, USB, HyperTransport, CSI, AGP, VLB), external bus controllers (parallel port, serial port, USB, Firewire, SCSI. PS/2, ISA, EISA, MCA), the power supply, case control with cooling fan, storage controllers (CD-ROM, DVD, DVD-ROM, DVD Writer, DVD RAM Drive, Blu-ray, BD-ROM, BD Writer, floppy disks, USB Flash, tape drives, SATA, SAS), video controllers, sound cards, network controllers (modem, NIC), and other peripherals, including mice, keyboards, pointing devices, scanners, audio devices, printers, display devices (e.g., monitors), etc.

For the purpose of the present invention, the term “user” refers to an individual (or group of individuals) who are using embodiments of the present invention. The term user may also refer to a computer which inputs instructions to a computer system.

For the purposes of the present invention, the term “machine-readable medium” refers to any medium or media on which may be read, for example, by a computer, or any other device capable of reading programmed machine-readable language or instructions. Examples of machine-readable media may include floppy disks, Zip™ disks, CD-ROM, CD-R, CD-RW, DVD, DVD-R, memory sticks, flash memory, hard disks (internal or external), optical disks, etc.

For the purposes of the present invention, the term “image” may refer one or more pictures, one or more photos, one or more designs, one or more alphanumeric characters, etc., or any combination thereof, and which may be displayed on a display device (e.g., monitor), or which may be printed on a printable paper substrate.

For the purposes of the present invention, the term “projected image” refers to one or more digital images which are displayed on a display device (e.g., monitor).

For the purposes of the present invention, the term “printed image” refers to one or more images printed on a printable paper substrate.

For the purposes of the present invention, the term “bitmap” (also referred to as a “pixmap”) refers to the conventional meaning of a spatial mapping of an array of bits (e.g., pixels) that may be used to store, define, etc., a digital image.

For the purposes of the present invention, the term “pixel” refers to conventional meaning of the smallest item of information in a digital image.

For the purposes of the present invention, the term “Internet” refers to a global system of interconnected computer networks that interchange data by packet switching using the standardized Internet Protocol Suite (TCP/IP). The Internet may carry various information resources and services, such as electronic mail, online chat, file transfer and file sharing, online gaming, and the inter-linked hypertext documents and other resources of the World Wide Web (WWW).

For the purposes of the present invention, the term “local area network (LAN)” refers to a network covering a small geographic area, such as a home, office, building, office site, etc. The defining characteristics of LANs, in contrast to WANs (wide area networks), include their higher data transfer rates, smaller geographic range, lack of a need for leased telecommunication lines, etc.

For the purposes of the present invention, the term “remotely accessible” (and related terms such as “remotely access”) refers to the ability to input, access, retrieve, download, transmit, etc., data, software, etc., which is stored remotely from the user by using a remote electronic transmission method.

For the purposes of the present invention, the term “activation code” refers to a security code (e.g., a product key, CD key, etc.) which may be in the form of a bar code, alphanumeric code, etc., which is required, needed, etc., for activating remotely accessible software, i.e., for making the software operable, usable, functioning, runable, etc. In some embodiments, the activation code may also function as a code for accessing the software, for installing, downloading, etc., the software onto a computer, a machine-readable medium, etc., for remotely using the software through, for example, a Web-based computer application, etc.

For the purposes of the present invention, the term “electronic database” refers to a database on which data, software, etc., is electronically stored on a computer, and which may be electronically accessed, for example, to input data, to input an activation code, etc., to retrieve data, software, etc.

For the purposes of the present invention, the term “sensor” refers to a collector and/or producer of information and/or data. A sensor may be a device or a living organism (e.g., a person). For example, a sensor may be a chemical or spectrophotometric analyzer (e.g., mass spectrometer, UV or infrared spectrometer, an ion-sensitive electrode etc.), an individual observing, measuring, etc., a characteristic (e.g., print quality), etc.

### DESCRIPTION

Embodiments of the system, method and product of the present invention are directed at providing the manufacturer, distributor, etc., of printable paper substrates with the ability to promote, to market, to enhance use of, etc., such products by providing printer controller software which may be advantageously or beneficially used with such products. The embodiments of the system, method and product of the present invention also provide the manufacturer with the ability to control use of, access to, etc., such printer controller software, including, for example, the duration of use of the software, the quantity of printable paper substrate that may be printed with the software, etc. In some embodiments of the system, method and product of the present invention, this printer controller software may be especially adapted, tailored, customized, adjusted, calibrated, etc., for use with the printable paper substrate and vice versa. The embodiments of the system, method and product of the present invention also provide the manufacturer with the ability to provide such printer controller software to a user without having to provide physical form of the software (e.g., a non-volatile electronic storage medium such as a CD or DVD) associated with the printable paper substrate, but with the software be easily, securely and remotely accessible (e.g., via the Internet) by the user of the printable paper substrate from an electronic storage system (e.g., a web site controlled by the manufacturer) so that the software may be accessed, downloaded and operated with the user's printer.

In the embodiment of the system of the present invention, an electronic database is provided for entry of an activation code. The activation code is provided with a discrete increment of the printable paper substrate which may be obtained, purchased, etc., by a user or which may be provided by the manufacturer to the user, for example, as a promotional distribution of a sample of the printable paper substrate. The printer controller software for use with the printable paper substrate is remotely accessible (e.g., may be downloaded) by the user and may be activated (e.g., made operable) by the user after entry into the electronic database of the activation code provided with the discrete increment of the printable paper substrate.

In embodiments of the method of the present invention, the user is provided with a discrete increment of the printable paper substrate. Again, the discrete increment of the printable paper substrate is provided with an activation code. The user enters the activation code into an electronic database. Entry of the activation code into the electronic database then permits the user to activate remotely accessible printer controller software for use with the printable paper substrate.

In embodiments of the product of the present invention, a discrete increment of the paper substrate is provided. An activation code is also provided with the discrete increment of printable paper substrate. The activation code may be entered by the user in the electronic database to again activate remotely accessible printer controller software to permit the user to use the printer controller software with the printable paper substrate.

In some embodiments of the system, method and product of the present invention, the printer controller software which is activated by the activation code provided with the discrete increment of printable paper substrate may provide the ability to reduce, decrease, etc., the quantity of printer colorant used per printable/printed paper substrate (e.g., reduced printer colorant usage software). For example, in some embodiments of the system, method and product of the present invention, the printer controller software activated by the activation code may provide reduced colorant usage (while also maintaining acceptable print quality) such as that described in commonly-assigned copending U.S. patent application Ser. No. 12/837,957 (Richard D. Faber), filed Jul. 16, 2010, the entire contents and disclosure of which is herein incorporated by reference (hereinafter referred to as the “'957 application”). The printer controller software disclosed in the '957 application provides the user of a printer associated with, for example, a computer, the ability to control (e.g., adjust) the printer operation (e.g., by intercepting a data stream or stream of print instructions to and/or from the computer and/or printer, and to process those same instructions) so that the printer (such an ink jet printer or laser printer) uses less ink/toner to print an image than would otherwise occur if the printer operation were not controlled (e.g., adjusted). This reduced usage of ink/toner may be achieved by having the printer controller software disclosed in the '957 application control deposition by the printer of the printer colorant from a source thereof (e.g., a printer cartridge) on the printable paper substrate to thereby reduce printer colorant usage in response to one or more of: (1) the identifying printer characteristics (data) of the printer; (2) the identifying printer colorant characteristics (data) of the printer colorant; (3) the print image quality criteria selected by the user; (4) the printer colorant reduction criteria selected by the user; or (5) the identifying printer colorant deposition characteristics (data) of the printable medium. For example, the printer controller software may respond to specific criteria such as one or more of: (a) the type of printer being used; (b) the type of ink/toner being used; or (c) the type of printable medium being used, wherein the printable paper substrate has specific print density characteristics, including print density characteristics for enhancing print density, such as printer colorant fixer (e.g., an ink/toner fixer) such as a water-soluble divalent metal ion, for example, calcium chloride.

In some embodiments of the system, method and product of the present invention, the activated printer controller software may be provided with a programmed time period for using the software (i.e., duration of software use), a programmed quantity (number) of printable paper substrate that may be printed with the software (which may be related to the discrete increment of printable paper substrate with which the activation code is provided), etc. In some embodiments of the system, method and product of the present invention, the duration of use, number of printable paper substrate, etc., for the printer controller software may be extended, increased, etc., by, for example, again entering the activation code provided with the increment of printable paper substrate into the electronic database, paying a proscribed extended use fee, and obtaining, for example, a new activation code for activating the printer controller software which is already installed to allow, permit, enable, etc., such extended use, to obtain a new installable and activated copy of the printer controller software, etc. In some embodiments of the system, method and product of the present invention, the user who obtained the discrete increment of printable paper substrate may be able to obtain authorization for multiple users to activate and use the printer controller software. For example, the user may enter the activation code into the electronic database, pay a proscribed multiple user fee, and then obtain one or more additional activation codes (i.e., a multiple user activation code) for the printer controller software. These obtained additional activation codes may then be entered into the electronic database by other users who may then activate the remotely accessible (e.g., a downloadable and an installable copy of) the printer controller software for use on computers of these other users.

Embodiments the system and method of the present invention are further illustrated in FIGS. 1 and 2. FIG. 1 is a schematic diagram which shows an illustrative system according to an embodiment of the present invention, which is generally indicated as 100. As shown in FIG. 1, system 100 may comprise, for example, a web site (indicated generally as 104), which includes an electronic database (indicated generally as 108) and a source of printer controller software (indicated generally as 112). Database 108 and software source 112 may be located on the same computer (e.g., server) or may be located on different computers, but, as shown by double-headed arrow 116 in FIG. 1, are at least in electronic communication with each other.

In order to activate the printer controller software in software source 112, database 108 needs to receive an activation code which is electronically transmitted to web site 104. This activation code is provided with a discrete increment (e.g., a ream) of printable paper substrate. In this regard, and as shown in FIG. 1, the activation code (indicated generally as 120), which may be in the form of alphanumeric characters, a bar code, etc., is associated with, attached to, printed on, etc., an activation code source (indicated generally as 124). Code source 124 may be the packaging for the discrete increment of the printable paper substrate on which activated code 120 is printed on the outside or inside), may be a tab, tag, sticker, label, etc., attached to the outside or inside of packaging, may be part of, attached to, printed on, etc., a package insert, card, enclosure, etc., may be attached to; printed on, etc., on one or more of the printable paper substrates, etc. As indicated by arrow 128, activation code 120 may be entered into a computer (indicated generally as 132) of the user of the printable paper substrate via an activation code input device (generally indicated as 136) which may be in the form of, for example, a computer keyboard, scanner, bar code reader, etc.

As indicated by arrows 140 and 144, user computer 132 may be in remote electronic communication (e.g., via the Internet, a LAN, a WAN, etc.) with web site 104. Initially, user computer 132 may send a request, as shown by arrow 140, to web site 104 which is entered into database 108 to, for example, access and download printer controller software from software source 112. Database 108 may then allow, permit, enable, etc., access, as shown by double-headed arrow 116, to software source 112 which may provide, for example, as installation copy of the printer controller software (e.g., in compressed or uncompressed format), a remotely accessible operating copy of such software, etc. The accessed printer controller software from software source 112 may then be transmitted (e.g., downloaded), as shown by arrow 144, to computer 132. The software transmitted to computer 132 may then be stored, installed, etc., on a software storage medium (indicated generally as 148) associated with computer 132 which may be, for example, the hard disk of user computer 132, a CD or DVD, etc.

After the transmission (e.g., downloading) of the printer controller software from web site 104 to computer 132/storage medium 148, activation code 120 entered into computer 132 via input device 136 is electronically transmitted (as shown by arrow 140) to web site 104 and is then entered into database 108. Database 108 receives and verifies the authenticity, validity, etc., of transmitted activation code 120. Upon database 108 verifying the authenticity, validity, etc., of transmitted activation code 120, another signal may then be sequentially transmitted (as shown by arrow 144) from web site 104 to computer 132 to activate the printer controller software stored on storage medium 148. Upon activation, the printer controller software stored on storage medium 148 may then be used in conjunction with a printer (not shown) to print images on a printable paper substrate.

Instead of sequentially transmitting the request to access the printer controller software from software source 112, followed by transmitting activation code 120 for verification, validation, etc., by electronic database 108, in some embodiments of system 100, the user may concurrently or simultaneously send, transmit, etc., a request for the printer controller software from source 112, along with activation code 120 (see arrow 140) to web site 104 to access, download, and activate the printer controller software from source 112. For example, transmitted activation code 120 by itself, upon verification, validation, etc., by database 108, may additionally serve as an access code to permit the printer controller software from source 112 to be accessed and downloaded, as well as activated. In other words, access to source 112 is not provided before transmitted activation code 120 is verified, validated, etc., by database 108. After verification, validation, etc., of transmitted activation code 120 by database 108, web site 104 may then permit access to, and downloading of (see arrow 144), an activated and operable copy of the printer controller software from source 112 to computer 132 which may then be stored for use on storage medium 148.

FIG. 2 is a flowchart which shows an illustrative method according to an embodiment of the present invention, which is indicated generally as 200. In method 200, a discrete increment (e.g., ream) of printable paper substrate is provided with an associated activation code (indicated in FIG. 2 as Increment with Code 202). As indicated arrow by 204, Increment with Code 202 is purchased by, obtained by, given to, distributed to, etc., a customer or user (indicated generally as User 206 in FIG. 2). User 206, as indicated by arrow 208, then enters a request to access and download printer controller software (indicated as Request Software step 210), as indicated by arrow 212, into the User 206's computer, indicated as Computer 214 (which also corresponds to computer 104 in FIG. 1). Computer 214, as indicated by arrow 216, may then transmit the request to access and download the software, as indicated by Transmit Software Request step 218. After Transmit Software Request step 218, the transmitted request reaches, as indicated by arrow 220, Web Site 222 (which also corresponds to web site 104 in FIG. 1). Web Site 222 then allows, permits, enables, etc., as indicated by arrow 224, access to, for example, downloading of the printer controller software from software source 112 (see FIG. 1), as indicated by Download Software step 226. After Download Software step 226, the downloaded printer controller software is transmitted to and then stored on Computer 214 (e.g., on storage medium 148 of FIG. 1), as indicated by arrow 228.

As indicated by arrow 230, after Download Software step 226 is carried out, User 206 may then sequentially enter the activation code (indicated by Enter Code step 232) into, for example, code input device 136 (see FIG. 1) and thus into Computer 214, as indicated by arrow 234. As indicated by arrow 236, Computer 214 then transmits the entered activation code, as indicated by Transmit Code step 238, with the transmitted activation code ultimately reaching Web Site 222, as indicated by arrow 240. After electronic database 108 verifies the authenticity, validity, etc., of the activation code received, Web Site 222 then transmits, as indicated by arrow 242, a software activation signal, as indicated by Activate Software step 244. As indicated by arrow 246, Computer 214 receives the activation signal from Web Site 222 which then activates the downloaded printer controller software stored on Computer 214 (e.g., on storage medium 148 of FIG. 1) for use by User 206. In some embodiments of method 200, Transmit Software Request step 218 and Transmit Code step 238 may be carried out concurrently or simultaneously to permit access to (e.g., downloading of), as well as activation of, the printer controller software, i.e., Download Software step 226 and Activate Software step 244 are also carried out concurrently or simultaneously. For example, the Transmit Code step 238 may also initiate Software Request step 218 to thereby cause Activate Software step 244 to be performed, followed by Download Software step 226.

All documents, patents, journal articles and other materials cited in the present application are hereby incorporated by reference.

Although the present invention has been fully described in conjunction with several embodiments thereof with reference to the accompanying drawings, it is to be understood that various changes and modifications may be apparent to those skilled in the art. Such changes and modifications are to be understood as included within the scope of the present invention as defined by the appended claims, unless they depart therefrom.

What is claimed is:

1. A system comprising:
an electronic database for entry of an activation code provided with a discrete increment of a printable paper substrate; and
printer controller software for use with the printable paper substrate which is remotely accessible by a user and which is activated after entry by the user of the activation code into the electronic database.

2. The system of claim 1, wherein the electronic database is remotely accessible by the user via a web site.

3. The system of claim 2, wherein the electronic database and a source of the printer controller software are located on different computers which are in electronic communication.

4. The system of claim 2, wherein the electronic database and a source of the printer controller are located on one computer.

5. The system of claim 1, wherein the electronic database verifies the authenticity or validity of the activation code after providing remote access to the printer controller software.

6. The system of claim 1, wherein the electronic database verifies the authenticity or validity of the activation code before providing remote access to the printer controller software.

7. The system of claim 1, wherein the electronic database concurrently or simultaneously verifies the authenticity or validity of the activation code and provides remote access to the printer controller software.

8. The system of claim 1, wherein the printer controller software is remotely accessible by the user as an installable copy of the printer controller software.

9. The system of claim 1, wherein the activation code is entered into a computer of the user, and wherein the activation code entered into the user's computer is then electronically transmitted for entry into the electronic database.

10. The system of claim 9, wherein the activation code entered into the computer of the user is an alphanumeric code.

11. The system of claim 9, wherein the activation code entered into the computer of the user is a bar code.

12. A method comprising the following steps:
a. providing a discrete increment of a printable paper substrate to a user, wherein the discrete increment is provided with an activation code; and
b. entering the activation code into an electronic database to permit the user to activate remotely access printer controller software for use with the printable paper substrate.

13. The method of claim 12, wherein step (b) is carried out by the user entering the activation code on a computer of the user, and wherein the activation code entered into the user's computer is electronically transmitted for entry into the electronic database.

14. The method of claim 12, wherein step (b) is carried out by the user downloading an installable copy of the printer controller software before entry of the activation code into the electronic database.

15. The method of claim 12, wherein step (b) is carried out by the user downloading an installable copy of the printer controller software after entry of the activation code into the electronic database.

16. The method of claim 12, wherein step (b) is carried out by the user concurrently or simultaneously transmitting the activation code and a request for access to the printer controller software.

17. The method of claim 12, wherein the printer controller software of step (b) is especially adapted for use with the printable paper substrate.

18. The method of claim 12, wherein the printer controller software of step (b) provides the ability for reduced printer colorant usage.

19. The method of claim 12, wherein step (b) is carried out by the electronic database verifying the authenticity or validity of the activation code entered into the database after providing remote access of the printer controller software to the user.

20. The method of claim 12, wherein step (b) is carried out by the electronic database verifying the authenticity or validity of the activation code entered into the database before providing remote access of the printer controller software to the user.

21. The method of claim 12, wherein the printer controller software of step (b) has a programmed time period for using the printer controller software or a programmed number of printable paper substrate that may be printed with the printer controller software.

22. The method of claim 21, wherein the programmed number of printable paper substrate of step (b) is related to the discrete increment printable paper substrate of step (a)

23. The method of claim 21, which comprises the following further steps of: (c) entering the activation code into the electronic database; (d) paying a proscribed extended use fee; and (e) obtaining a new activation code for extending use of the printer controller software.

24. The method of claim 12, which comprises the following further steps of: (c) entering the activation code into the electronic database; (d) paying a proscribed multiple user fee; and (e) obtaining one or more additional activation codes for the printer controller software.

25. A product comprising:
a discrete increment of a paper substrate; and
an activation code provided with the discrete increment and which may be entered by a user into an electronic database to activate remotely accessible printer controller software to permit the user to use the printer controller software with the printable paper substrate.

26. The product of claim 25, wherein the discrete increment comprises a plurality of printable paper substrate sheets.

27. The product of claim 26, wherein the plurality of printable paper substrate sheets comprises a ream of printable paper substrate sheets.

28. The product of claim 27, wherein the ream of printable paper substrate sheets comprises from about 480 to about 516 printable paper substrate sheets.

29. The product of claim 25, wherein the activation code is provided as an alphanumeric code.

30. The product of claim 25, wherein the activation code is provided as a bar code.

31. The product of claim 25, wherein the activation code is associated with, attached to, or printed on packaging for the discrete increment.

32. The product of claim 25, wherein the activation code is associated with, attached to, or printed on a tab, sticker, or label attached to the packaging for the discrete increment.

33. The product of claim 25, wherein the activation code is part of, attached to, or printed on a package insert, card, or enclosure.

34. The product of claim 25, wherein the activation code is attached to or printed on one or more printable paper substrates.
